(19) United States
(12) Patent Application Publication
(10) Pub. No.: US 2024/0257255 A1
(43) Pub. Date: Aug. 1, 2024

(54) SYSTEMS AND METHODS FOR PREDICTING CRYPTOGRAPHIC ASSET DISTRIBUTIONS

(71) Applicant: Coinbase, Inc., Oakland, CA (US)

(72) Inventors: Rajarshi GUPTA, Los Altos, CA (US); Bhaskar KRISHNAMACHARI, Los Angeles, CA (US)

(73) Assignee: Coinbase, Inc., Oakland, CA (US)

(21) Appl. No.: 18/163,158

(22) Filed: Feb. 1, 2023

(51) Int. Cl. G06Q 40/06

(52) U.S. Cl. CPC G06Q 40/06

(57) ABSTRACT

Methods and systems are described herein for predicting cryptographic asset distributions for a future period of time using artificial intelligence and/or machine learning (AI/ML) models. A system may receive a first dataset comprising time-series data over a past period of time. The cryptographic asset may be used to secure a blockchain. The system may determine, using AI/ML models with the first dataset, a prediction of the cryptographic asset distributions for the future period of time, wherein a cryptographic asset distribution occurs in response to a respective cryptographic asset being used to secure a respective blockchain. The system may also determine characteristics about a user and generate a recommendation to secure the blockchain based on the prediction and the one or more characteristics about the user.

### BACKGROUND

In recent years, the use of blockchains and blockchain technology has exponentially increased. Blockchains comprise a list of records, called “blocks,” that are “chained” together using cryptography. Each block may comprise data that is computed using a one-way function (e.g., a function that is practically impossible to invert or reverse-compute) of a previous block, a timestamp (e.g., indicating a creation and/or modification time), and additional data (e.g., transactional or operational data related to blockchain operations).

While publicity for blockchains and blockchain technology has been concentrated on its use for cryptocurrencies and smart contracts, blockchains and blockchain technology may be applicable to numerous technological avenues. A common theme of the technological avenues is the manner in which blockchains and blockchain technology are decentralized such that facilitation, management, and/or verification of blockchain-based operations is governed or administered not by any one authority but instead by a community of users. The blockchain may therefore remain distributed (e.g., on a network of computers that communicate and coordinate their actions by passing messages to one another), and in many cases public, through a digital ledger, which records the series of blocks forming the chain. Notably, because each block depends on a preceding block, edits to existing blocks in the chain may not be made without affecting subsequent blocks.

Furthermore, updates to the blockchain (e.g., the addition of new blocks) may include incentivization systems that reward community members for the generation of the updates while also ensuring a consensus by the community. By doing so, the proliferation of the blockchain may proceed indefinitely.

### SUMMARY

Systems and methods are described herein for novel uses and/or improvements to blockchains and blockchain technology. As one example, methods and systems are described herein for predicting cryptographic asset distributions for a period of time in the future using one or more artificial intelligence and/or machine learning models.

Securing a blockchain using cryptographic assets (e.g., staking) is the process of holding cryptographic assets, such as cryptographic tokens (e.g., non-fungible tokens (NFTs), fungible tokens, etc.) in a cryptography-based storage application (e.g., cryptocurrency wallet, digital wallet, etc.) to support operations on a blockchain network. It may involve locking cryptographic assets as collateral to validate transactions and earn an amount of cryptographic asset (e.g., a “reward”) in return. Depending on factors such as the cryptography platform a user uses, a user's preferences as to risk tolerance, available alternatives and external market conditions, the amount of earned cryptographic asset as a result can be highly variable and volatile. Conventional systems fail to provide reliable predictions in cryptographic asset distributions in the future (e.g., how much “reward” a user may expect to receive), making it difficult or impossible for users to make informed decisions on whether or not to secure a blockchain (e.g., stake) using cryptographic assets (e.g., cryptographic tokens). For example, conventional systems fail to predict future trends of cryptographic asset distributions, especially based on historic data, user preferences, and market conditions.

To overcome these technical deficiencies in conventional systems, systems and methods disclosed herein predict cryptographic asset distributions for a future period of time using one or more artificial intelligence and/or machine learning models. For example, the artificial intelligence and/or machine learning model may be trained on one or more datasets comprising time-series data over a past period of time corresponding to cryptographic assets as well as a variety of other factors such as sentiment analysis using social media and news trends. The predictions may then be used to generate recommendations to a user, e.g., based on their preferences. Accordingly, the systems and methods provide for the user the ability to make informed decisions and/or actions regarding securing a blockchain with respect to the cryptographic asset.

In some aspects, the methods and systems disclosed herein may be used for predicting cryptographic asset distributions for a future period of time using one or more artificial intelligence and/or machine learning models. The system may receive a first dataset comprising time-series data over a past period of time corresponding to a first cryptographic asset, wherein the first cryptographic asset is used to secure a first blockchain. The system may use the one or more artificial intelligence and/or machine learning models with the first dataset to determine a prediction of the cryptographic asset distributions for the future period of time, wherein a cryptographic asset distribution occurs in response to a respective cryptographic asset being used to secure a respective blockchain. The system may then determine one or more characteristics about a user with one or more cryptographic assets, such as a risk tolerance and/or the like. The system may then generate a recommendation to secure the first blockchain (e.g., stake) using the first cryptographic asset, wherein the recommendation is based on the prediction of the cryptographic asset distributions for the future period of time and the one or more characteristics about the user; and then may further display of the recommendation to secure the first blockchain using the first cryptographic asset. In some examples, the first dataset may further comprise time-series data over the past period of time corresponding to a second cryptographic asset for securing a second blockchain and the recommendation may be to secure the first blockchain, as compared to the second blockchain (e.g., based on which cryptographic asset would yield a higher cryptographic asset distribution in the future if a user were to stake the asset currently).

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for predicting cryptographic asset distributions for a period of time in the future using one or more artificial intelligence and/or machine learning models, in accordance with one or more embodiments.

FIG. 2 shows an illustrative diagram for conducting blockchain operations, in accordance with one or more embodiments.

FIG. 3 shows an illustrative diagram for a decentralized application, in accordance with one or more embodiments.

FIG. 4 shows an illustrative diagram for conducting operations in a decentralized application using blockchain operations, in accordance with one or more embodiments.

FIG. 5 shows an illustrative diagram for a blockchain indexer, in accordance with one or more embodiments.

FIG. 6 shows a flowchart of the steps involved in predicting cryptographic asset distributions for a period of time in the future using one or more artificial intelligence and/or machine learning models, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

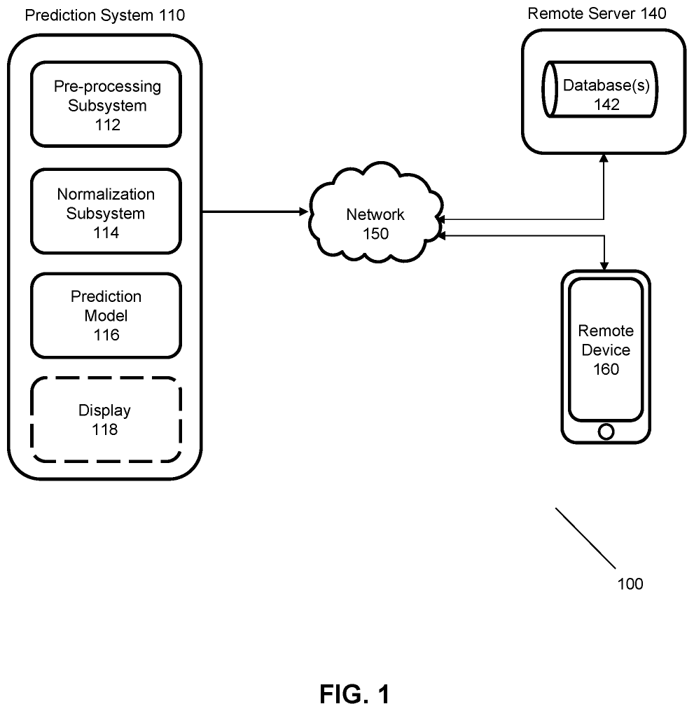

FIG. 1 shows an illustrative diagram for predicting cryptographic asset distributions for a future period of time using one or more artificial intelligence and/or machine learning models, in accordance with one or more embodiments. For example, environment 100 includes a prediction system 110, remote server 140, and remote device 160. Each of prediction system 110, remote server 140 and remote device 160 may be in communication via network 150. Network 150 may be a wired or wireless connection such as a local area network, a wide area network (e.g., the Internet), or a combination of the two. The prediction system 110 may be used to predict cryptographic asset distributions for a future period of time using one or more artificial intelligence and/or machine learning models.

Prediction system 110 may obtain one or more data inputs. For example, the prediction system 110 may receive the one or more data inputs from a database, such as database 142 of a remote server 140, for example, in response to requesting the data inputs from remote server 140. In some examples, the prediction system 110 may obtain the one or more data inputs from a remote device, such as remote device 160 via network 150. Alternatively, and/or additionally, one or more data inputs may be stored locally at the prediction system 110.

The data inputs may include real-time and historical time-series data on securing a blockchain using a cryptographic asset and/or ceasing securing a blockchain using a cryptographic asset, such as volume of cryptographic assets used to secure the blockchain over time. One example of data inputs includes current and past time-series data on staking and unstaking volumes over time. In some examples, the data inputs may include time-series data on a number of users who have secured a blockchain using cryptographic assets, such as a number of stakers (number of unique addresses involved with staking). In some examples, the data inputs may include time-series data on market capitalization and asset price and other market indicators over time. In some examples, the data inputs may include time-series data on cryptographic asset value creation rate (e.g., staking reward rate). In some examples, the data inputs may include blockchain-based data (e.g., a time-series) on distribution of cryptographic assets used to secure blockchains held across different cryptography-based storage applications, e.g., staked tokens held across different addresses/wallets. In some examples, the data inputs may include blockchain-based data pertaining to relevant transactions on relevant platforms, e.g., synthetic derivatives related to the staked asset or liquid staking protocols, trading of relevant tokens on decentralized exchanges, etc. In some examples, the data inputs may include time-series data on general cryptocurrency and financial market indicators (prices of popular assets or market indices). In some examples, the data inputs may include identification and observation of activities of key “whale” traders, institutional investors, staking providers. In some examples, the data inputs may include search trends data for relevant keywords pertinent to the cryptographic asset, social media, news sources, activity on platforms, and/or any other data available from the World Wide Web or other Internet sources (e.g., Web-2 data).

According to some embodiments, the data input(s) may be input into preprocessing subsystem 112 to preprocess the data input(s) or normalization subsystem 114 to normalize the data input(s), e.g., to obtain datasets such as time-series data. In some cases, the data input(s) may be input into both the preprocessing subsystem 112 and normalization subsystem 114 for standardizing the data input(s) generally (e.g., using both preprocessing and normalization). For example, in some cases data inputs may be obtained by prediction system 110 originally in a raw format that may not be quantitative. In this case, additional pre-processing may be needed to quantify the input and convert it into a standard format such as a time-series input.

For example, if the prediction model 116 needs to use data from social media, a set of posts with a given topic or hashtag over a given time period may first be pre-processed using a sentiment analysis model that outputs a quantitative score for how positively or negatively the cryptographic asset in question is being perceived for that time-index. According to some examples, the preprocessing subsystem 112 may include one or more custom preprocessing models, e.g., in the case of non-traditional data sources. For example, the preprocessing subsystem 112 may include a trained model such as an artificial intelligence (AI) model, a machine learning (ML) model, a formula (e.g., explicit formula) or a software defined function that converts observations of software development activity for a platform such as through measurements of numbers of lines of code, numbers of pull requests, numbers of active developers, discussion posts, as well as direct analysis of public code deployment on online repositories (such as on GitHub) relevant to a particular platform, to a score that predicts how actively maintained that platform is over a specified time period. The data may additionally be converted to a time-series input for the prediction model 116.

Additionally or alternatively, the preprocessing subsystem 112 and/or normalization subsystem 114 may include functions to the various pre-processed time series to deal with noise (e.g., by smoothing methods), missing data (e.g., by appropriate interpolation methods), to normalize the data (e.g., to apply a logarithmic transformation to price data that varies over many magnitudes, and/or scaling by a constant to keep the maximum values below some specified level). For example, preprocessing steps included in the preprocessing subsystem 112 may include preprocessing using an existing or custom model to generate time series data and/or additional pre-processing for denoising, interpolation and normalization of each set of time series. As described herein, the output of preprocessing subsystem 112 may further be processed to normalize the time series to a normalized form. Alternatively, and/or additionally, some data inputs may not require any preprocessing by preprocessing subsystem 112 and/or normalization by normalization subsystem 114.

Raw data inputs, preprocessed data, and/or normalized data may then be input into prediction model 116 of prediction system 110. For example, the input data may include datasets including information on volume data (e.g., a volume of cryptographic assets used to secure the blockchain), cryptographic asset value creation data, transaction data, and/or value data. According to some embodiments, the data input may be preprocessed and/or normalized such that the resulting data input into prediction model 116 is represented as a discrete time-series at a certain granularity, e.g., as a series of numbers where the time-index corresponds to specified days or hours. In some embodiments, the data input may be preprocessed and/or normalized to be represented as a vector time-series, e.g., as a series of vectors where for each time-index there is a vector of fixed size. For example, an input representing the price of a set of assets such that at each time index the price of that set of assets could be represented as a vector whose size is the number of assets.

One or more datasets including time-series data over a past period of time corresponding to one or more cryptographic assets may be input into prediction model 116. Using the one or more datasets, the prediction model may determine a prediction of the cryptographic asset distributions for the future period of time. As referred to herein, a cryptographic token distribution may occur in response to a respective cryptographic token being used to secure a respective blockchain. In some examples, a cryptographic token distribution can include an amount or volume of cryptographic assets distributed (e.g., rewards distributed, for example, as a result of staking). For example, a cryptographic token distribution can include an encrypted communication load. As referred to herein, an encrypted communication load may describe a metric associated with cryptographic asset distribution, such as an amount or volume of cryptographic assets distributed (e.g., rewards distributed, for example, as a result of staking) given that a particular cryptographic asset is used to secure a corresponding blockchain. In some examples, an encrypted communication load may refer to a total amount or total volume of cryptographic assets distributed. In one example, the cryptographic token distribution may refer to a “reward” distribution (e.g., cryptographic assets earned) for staking cryptographic tokens.

In some examples, the prediction model 116 may also output a time-series prediction of the cryptographic token value creation rate (e.g., staking rewards rate (APY)) over the next several time periods. For example, the prediction model 116 may output an annual rate of return that a user can expect to earn by staking their cryptographic assets (e.g., cryptocurrency, cryptographic tokens, etc.) such as asset staking rewards (APR) over the next several time periods. The number of time periods that the prediction is made over may be a tunable parameter of the model. For example, a user may tune the model based on the user's preferences. In some examples, the cryptographic token value creation rate (e.g., asset staking rewards (APR)) may be a single number for each future time period or could also additionally provide for each future time period also some measure of uncertainty of the prediction (e.g., standard deviation, or a histogram showing probabilities associated with different possible predicted values). Alternatively and/or additionally, the prediction model 116 may output a time-series prediction of the total volume of cryptographic asset used to secure the blockchain (e.g., used to stake). In some examples, the volume may be a single number and/or include some measure of uncertainty in the prediction over time as described herein.

Prediction model 116 may include one or more artificial intelligence and/or machine learning models. Prediction model 116 may include an indirect model, a direct model, or a combination of both models, where each of the indirect and direct model may include an artificial intelligence and/or machine learning model. As referred to herein an indirect model may predict a metric relevant to the cryptographic asset distribution, such as the encrypted communication load (e.g., total volume of assets) that will be used to secure the blockchain (e.g., staked) over given time periods. The total time period and how it is discretized can be defined when training the model (e.g., the output of the model may be a prediction of the APR of the asset on a daily basis over the next month). Known rules and policies for securing on that platform (e.g., mapping from an amount of cryptographic assets used to secure the blockchain (e.g., staked) to an amount of cryptographic assets earned (e.g., staking rewards), or any restrictions on an amount of time during which a cryptographic asset may be used to secure the blockchain (e.g., staking duration)) could then be used to determine the predicted staking reward. Or alternatively, the output(s) of the indirect model could be used as an input to the direct model described herein. As referred to herein, a direct model is a staking reward prediction model. Such a model would directly predict what the cryptographic token value creation rate (e.g., asset staking rewards (APR)) will be over a given time period. The direct model could either work entirely with the preprocessed data as inputs or also input the output of the above-described indirect model in addition to preprocessed data inputs. For example, the prediction model may include a direct model and the system may input one or more datasets into an artificial intelligence and/or machine learning model of the direct model, where the artificial intelligence and/or machine learning model is trained to determine a prediction of a cryptographic asset value creation rate associated with respective cryptographic assets being used to secure respective blockchains. As a result, the model output from the first artificial intelligence and/or machine learning model may indicate the prediction of the cryptographic asset value creation rate associated with respective cryptographic assets being used to secure respective blockchains.

Alternatively and/or additionally, each of these models and subsystems may be used in different configurations. For example, according to one embodiment, the pre-processed data sources may feed into the direct model only, and outputs may include a prediction for cryptographic asset distributions (e.g., staking rewards predictions). In another embodiment, pre-processed data sources feed into the indirect model, whose outputs all feed into a deterministic calculation that then outputs a prediction for cryptographic asset distributions. The volume of staked asset prediction from the indirect model is an additional output of the model. For example, the prediction model may include an indirect model and the system may input one or more datasets into an artificial intelligence and/or machine learning model trained to determine predictions of the cryptographic asset distributions. As a result, the system may obtain a model output from the artificial intelligence and/or machine learning model indicating the prediction of the cryptographic asset distributions for the future period of time.

For example, according to one configuration, the prediction system may include both a direct model and an indirect model. The system may input one or more datasets into a first artificial intelligence and/or machine learning model of the indirect model and receive the model output of the indirect model (e.g., a prediction for cryptographic asset value creation rate). The model output of the indirect model and one or more other datasets may be input into a second artificial intelligence and/or machine learning model of the direct model, where the second artificial intelligence and/or machine learning model is trained to determine a prediction of a value associated with respective cryptographic assets being used to secure respective blockchains. The model output from the second artificial intelligence and/or machine learning model can indicate the prediction of a value associated with respective cryptographic assets being used to secure respective blockchains, such as a prediction for staked asset volume over different periods of time in the future, and/or predictions for staking rewards over different periods of time in the future.

The outputs of prediction model 116 may be used to generate recommendations for securing the blockchain using a cryptographic token or to cease securing the blockchain (e.g., staking/unstaking) to a user such as an exchange or institutional investor and/or an individual investor. The recommendation may then be provided to a user via display 118, and via a remote device 160 through network 150.

In one example, given a set of cryptographic assets, a system (e.g., prediction system 110) may include a prediction model 116 comprising models corresponding to each of the cryptographic assets. The prediction model 116 may output a time-series of predicted mean rewards over the next N time periods as well as a time-series of predicted standard deviations of these rewards. Based on a metric, prediction system 110 may rank the cryptographic assets and provide the ranking to the user, such that the user can select one or more cryptographic assets to use for staking. For example, one metric that could be used to rank the assets could be using the expected (predicted) discounted return for securing a blockchain using a specific cryptographic asset. Another metric that could be used to rank the assets could be to use the expected discounted ratio of return to risk (measured by the standard deviation). Other metrics may additionally take into account trends in the predicted return, e.g., whether the returns (e.g., rewards) are predicted to be increasing or decreasing over the future time period being considered.

In some examples, prediction system 110 may use a threshold-based recommendation such that the system generates a recommendation recommending securing blockchains using all cryptographic assets (e.g., for staking all assets) for which the predicted metrics such as expected discounted return or expected discounted return to risk ratios are above some given threshold, and to not recommend assets for which these metrics are below some threshold. Alternatively, the recommendation could be implemented by using a trained AI/ML model that is trained to take as an input the predicted staking asset rewards (mean and standard deviations) and output a binary decision. For example, the model may output 1 to recommend the asset and 0 to not recommend the asset. Such a model could be trained based on historical performance data.

In some examples, a recommendation may be based on additional data about the user that could be helpful in understanding their preference for staking different assets, risk tolerance, etc. In some examples, prediction system 110 may determine one or more characteristics about a user, e.g., with one or more cryptographic assets, by retrieving data regarding the user from a database such as database 142 of a remote server 140, or via a remote device 160, and/or through interaction with the prediction system 110 (e.g., via display 118). The recommendation for which asset to recommend could then take into account both the data about the individual as well as the metrics associated with the cryptographic asset rewards prediction (such as expected discounted return or expected discounted return to risk ratio metrics described above) to make a recommendation about each asset. The final recommendation would then be personalized for each individual user, and could be presented as either an unordered or ranked list of which assets the user may wish to use to secure (e.g., stake).

According to some embodiments, determining the one or more user characteristics may include obtaining user data associated with preferences of the user (e.g., via the database, via user selection of preferences using the display and/or remote device) and determining, based on the user data, an individual risk tolerance. For example, based on a user's response to one or more questions or using one or more indicated preferences (e.g., if a user indicates that they prefer a high level of risk to optimize an amount of cryptographic assets earned), the system may determine one or more levels of risk regarding different dimensions specific to a user. In one example, the user may indicate that they prefer not to stake assets if market conditions are low, or if the price of the cryptographic asset has fluctuated a lot in the past. Based on the preferences stated by the user, the system may determine a level of risk tolerance specific to a user.

According to some embodiments, determining the one or more user characteristics may include using historic behavior, e.g., of the user. For example, determining the one or more user characteristics may include obtaining user data (e.g., from a remote device, from a database) regarding one or more previous blockchains secured using the one or more cryptographic assets by the user. The system may then determine, based on the user data, historical behavior of the user, such as how much cryptographic asset a user had previously staked and/or the like.

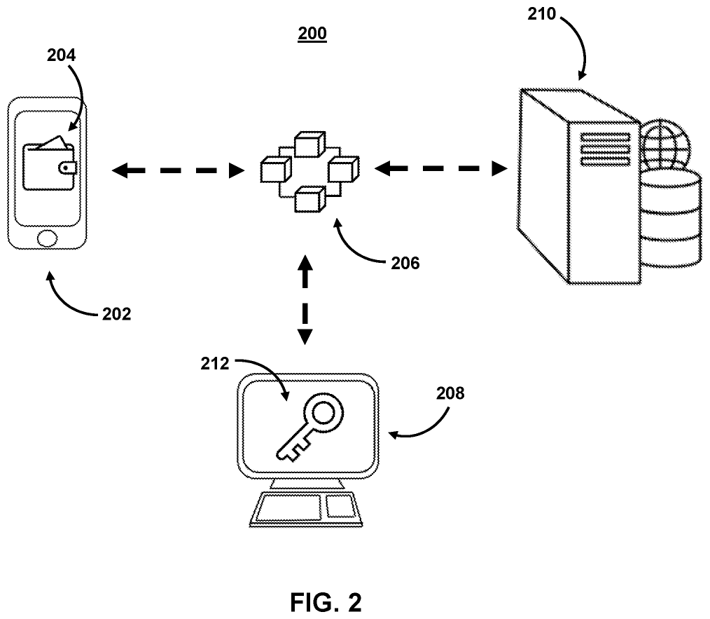

FIG. 2 shows an illustrative diagram for conducting blockchain operations, in accordance with one or more embodiments. For example, the diagram presents various components that may be used to determine a prediction using one or more artificial intelligence and/or machine learning models, in some embodiments.

FIG. 2 includes user device 202. User device 202 may include a user interface. As referred to herein, a “user interface” may comprise a mechanism for human-computer interaction and communication in a device and may include display screens, keyboards, a mouse, and the appearance of a desktop. For example, a user interface may comprise a way a user interacts with an application or website in order to determine a prediction using one or more artificial intelligence and/or machine learning models, and the user interface may display content related to determining a prediction using one or more artificial intelligence and/or machine learning models, such as causing display of the recommendation to secure a blockchain using a corresponding cryptographic asset, or displaying a recommendation to cease securing the blockchain using the corresponding cryptographic token. As referred to herein, “content” should be understood to mean an electronically consumable user asset, representations of goods or services (including nonfungible tokens), Internet content (e.g., streaming content, downloadable content, webcasts, etc.), video data, audio data, image data, and/or textual data, etc.

As shown in FIG. 2, system 200 may include multiple user devices (e.g., user device 202, user device 208, and/or user device 210). For example, system 200 may comprise a distributed state machine, in which each of the components in FIG. 2 acts as a client of system 200. For example, system 200 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system.

It should be noted that, while shown as a smartphone, a personal computer, and a server in FIG. 2, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments that describe system 200 performing a blockchain operation may equally be applied to, and correspond to, an individual user device (e.g., user device 202, user device 208, and/or user device 210) performing the blockchain operation. That is, system 200 may correspond to the user devices (e.g., user device 202, user device 208, and/or user device 210) collectively or individually.

Each of the user devices may be used by the system to conduct blockchain operations and/or contribute to determining a prediction using one or more artificial intelligence and/or machine learning models. As referred to herein, “blockchain operations” may comprise any operations including and/or related to blockchains and blockchain technology. For example, blockchain operations may include conducting transactions, querying a distributed ledger, generating additional blocks for a blockchain, transmitting communications-related nonfungible tokens, performing encryption/decryption, exchanging public/private keys, and/or other operations related to blockchains and blockchain technology. In some embodiments, a blockchain operation may comprise the creation, modification, detection, and/or execution of a smart contract or program stored on a blockchain. For example, a smart contract may comprise a program stored on a blockchain that is executed (e.g., automatically, without any intermediary's involvement or time loss) when one or more predetermined conditions are met. In some embodiments, a blockchain operation may comprise the creation, modification, exchange, and/or review of a token (e.g., a digital blockchain-specific asset), including a nonfungible token. A nonfungible token may comprise a token that is associated with a good, a service, a smart contract, and/or other content that may be verified by, and stored using, blockchain technology.

In some embodiments, blockchain operations may also comprise actions related to mechanisms that facilitate other blockchain operations (e.g., actions related to metering activities for blockchain operations on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain operation (e.g., computation, data access, transaction, etc.). Each blockchain operation has a predetermined cost in units of gas (e.g., as determined based on a predefined set of rules for the system). When a blockchain operation triggers the execution of a smart contract, the blockchain operation may include an amount of gas that sets the upper limit of what can be consumed in running the smart contract. The system may terminate execution of the smart contract if the amount of gas consumed by computation exceeds the gas available in the blockchain operation. For example, in Ethereum, gas comprises a mechanism for allowing Turing-complete computation while limiting the resources that any smart contract and/or blockchain operation may consume.

In some embodiments, gas may be obtained as part of a blockchain operation (e.g., a purchase) using a network-specific cryptocurrency (e.g., ether in the case of Ethereum). The system may require gas (or the amount of the network-specific cryptocurrency corresponding to the required amount of gas) to be transmitted with the blockchain operation as an earmark to the blockchain operation. In some embodiments, gas that is earmarked for a blockchain operation may be refunded back to the originator of the blockchain operation if, after the computation is executed, an amount remains unused.

As shown in FIG. 2, one or more user devices may include a cryptography-based, storage application (e.g., digital wallet 204) used to perform blockchain operations. The cryptography-based, storage application may be used to perform a plurality of blockchain operations across a computer network. The cryptography-based, storage application may in some embodiments, correspond to a digital wallet. For example, the digital wallet may comprise a repository that allows users to store, manage, and trade their cryptocurrencies and assets, interact with blockchains, and/or conduct blockchain operations using one or more applications. The digital wallet may be specific to a given blockchain protocol or may provide access to multiple blockchain protocols. In some embodiments, the system may use various types of wallets such as hot wallets and cold wallets. Hot wallets are connected to the internet while cold wallets are not. Digital wallet holders may hold both a hot wallet and a cold wallet. Hot wallets are most often used to perform blockchain operations, while a cold wallet is generally used for managing a user account and may have no connection to the internet.

In some embodiments, the cryptography-based, storage application may correspond to a key-based wallet or a smart contract wallet. For example, a key based wallet may feature public or private keys and allow a user to either have control of the account or receive transactions in the account. A smart contract wallet may comprise blockchain programs or digital agreements that execute transactions between parties once a predetermined condition is met. For example, a smart contract wallet may be managed by a smart contract (e.g., or smart contract code) instead of a private key. As such, a smart contract wallet may improve speed, accuracy, trust, and/or transparency in blockchain operations. In some embodiment, a cryptography-based, storage application may include, or have access to, key-based wallet or a smart contract wallet. For example, the cryptography-based, storage application may comprise a digital or other construct (e.g., a reference, a pointer, a text on a blockchain, an address, etc.).

As shown in FIG. 2, one or more user devices may include a private key (e.g., key 212) and/or digital signature. For example, system 200 may use cryptographic systems for conducting blockchain operations such as securing a blockchain using one or more cryptographic assets, e.g., staking cryptographic assets, based on a prediction cryptographic token distributions for a future period of time generated using one or more artificial intelligence and/or machine learning models. For example, system 200 may use public-key cryptography, which features a pair of digital keys (e.g., which may comprise strings of data). In such cases, each pair comprises a public key (e.g., which may be public) and a private key (e.g., which may be kept private). System 200 may generate the key pairs using cryptographic algorithms (e.g., featuring one-way functions). System 200 may then encrypt a message (or other blockchain operation) using an intended receiver's public key such that the encrypted message may be decrypted only with the receiver's corresponding private key. In some embodiments, system 200 may combine a message with a private key to create a digital signature on the message. For example, the digital signature may be used to verify the authenticity of blockchain operations. As an illustration, when conducting blockchain operations, system 200 may use the digital signature to prove to every node in the system that it is authorized to conduct the blockchain operations.

For example, system 200 may comprise a plurality of nodes for the blockchain network. Each node may correspond to a user device (e.g., user device 208). A node for a blockchain network may comprise an application or other software that records and/or monitors peer connections to other nodes and/or miners for the blockchain network. For example, a miner comprises a node in a blockchain network that facilitates blockchain operations by verifying blockchain operations on the blockchain, adding new blocks to the existing chain, and/or ensuring that these additions are accurate. The nodes may continually record the state of the blockchain and respond to remote procedure requests for information about the blockchain.

For example, user device 208 may request a blockchain operation (e.g., conduct a transaction). The blockchain operation may be authenticated by user device 208 and/or another node (e.g., a user device in the community network of system 200). For example, using cryptographic keys, system 200 may identify users and give access to their respective user accounts (e.g., corresponding digital wallets) within system 200. Using private keys (e.g., known only to the respective users) and public keys (e.g., known to the community network), system 200 may create digital signatures to authenticate the users.

Following an authentication of the blockchain operation (e.g., using key 212), the blockchain operation may be authorized. For example, after the blockchain operation is authenticated between the users, system 200 may authorize the blockchain operation prior to adding it to the blockchain. System 200 may add the blockchain operation to blockchain 206. System 200 may perform this based on a consensus of the user devices within system 200. For example, system 200 may rely on a majority (or other metric) of the nodes in the community network (e.g., user device 202, user device 208, and/or user device 210) to determine that the blockchain operation is valid. In response to validation of the block, a node user device (e.g., user device 202, user device 208, and/or user device 210) in the community network (e.g., a miner) may receive a reward (e.g., in a given cryptocurrency) as an incentive for validating the block.

To validate the blockchain operation, system 200 may use one or more validation protocols and/or validation mechanisms. For example, system 200 may use a proof-of-work mechanism in which a user device must provide evidence that it performed computational work to validate a blockchain operation and thus this mechanism provides a manner for achieving consensus in a decentralized manner as well as preventing fraudulent validations. For example, the proof-of-work mechanism may involve iterations of a hashing algorithm. The user device that is successful aggregates and records blockchain operations from a mempool (e.g., a collection of all valid blockchain operations waiting to be confirmed by the blockchain network) into the next block. Alternatively or additionally, system 200 may use a proof-of-stake mechanism in which a user account (e.g., corresponding to a node on the blockchain network) is required to have, or “stake,” a predetermined amount of tokens in order for system 200 to recognize it as a validator in the blockchain network.

In response to validation of the block, the block is added to blockchain 206, and the blockchain operation is completed. For example, to add the blockchain operation to blockchain 206, the successful node (e.g., the successful miner) encapsulates the blockchain operation in a new block before transmitting the block throughout system 200.

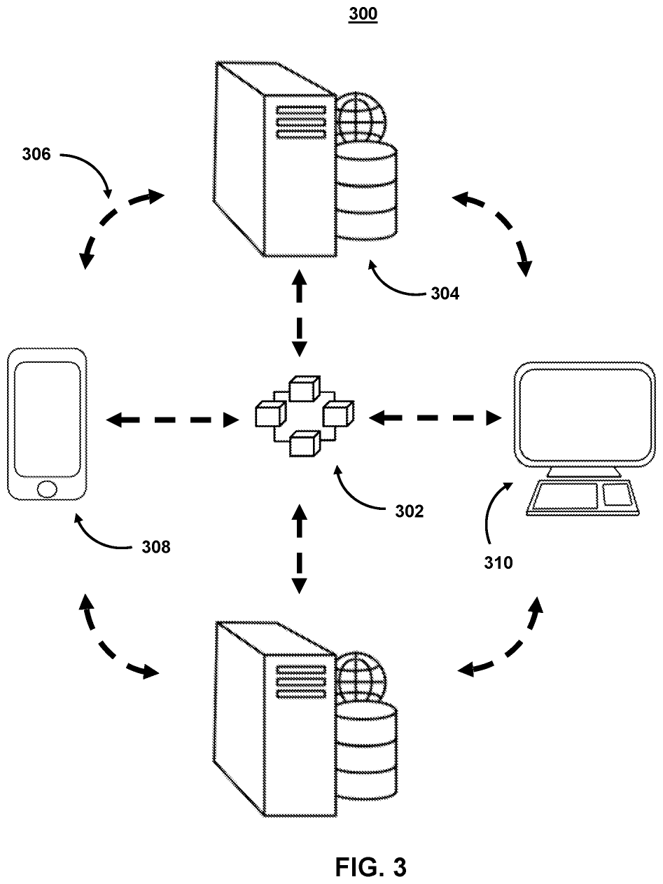

FIG. 3 shows an illustrative diagram for a decentralized application, in accordance with one or more embodiments. For example, in some embodiments, system 300 may be used to secure a blockchain using one or more cryptographic assets based on, for example, a prediction cryptographic token distributions for a future period of time generated using one or more artificial intelligence and/or machine learning models within a decentralized application environment. A decentralized application may comprise an application that exists on a blockchain (e.g., blockchain 302) and/or a peer-to-peer network (e.g., network 306). That is, a decentralized application may comprise an application that has a back end that is in part powered by a decentralized peer-to-peer network such as a decentralized, open-source blockchain with smart contract functionality.

For example, network 306 may allow user devices (e.g., user device 304) within network 306 to share files and access. In particular, the peer-to-peer architecture of network 306 allows blockchain operations (e.g., corresponding to blockchain 302) to be conducted between the user devices in the network, without the need of any intermediaries or central authorities.

In some embodiments, the user devices of system 300 may comprise one or more cloud components. For example, cloud components may be implemented as a cloud computing system and may feature one or more component devices. It should also be noted that system 300 is not limited to four devices. Users may for instance, utilize one or more devices to interact with one another, one or more servers, or other components of system 300. It should be further noted that while one or more operations (e.g., blockchain operations) are described herein as being performed by a particular component (e.g., user device 304) of system 300, those operations may in some embodiments, be performed by other components of system 300. As an example, while one or more operations are described herein as being performed by components of user device 304, those operations may in some embodiments, be performed by one or more cloud components. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components (e.g., user device 304 and user device 308, respectively). Additionally, or alternatively, a single user (and/or a user account linked to a single user) may interact with system 300 and/or one or more components of system 300 using two different components (e.g., user device 304 and user device 308, respectively).

With respect to the components of system 300, each of these devices may receive content and data via input/output (hereinafter “I/O”) paths using I/O circuitry. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both the user device 308 and user device 310 include a display upon which to display data (e.g., content related to one or more blockchain operations).

Additionally, the devices in system 300 may run an application (or another suitable program). The application may cause the processors and/or control circuitry to perform operations related to securing a blockchain as described herein within a decentralized application environment.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more optically readable storage media (e.g., optical disk, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes network 306, which may comprise communication paths between user devices. The communication paths may include the Internet, a mobile phone network, a mobile voice or data network (e.g., a 5G or LTE network), a cable network, a public switched telephone network, or other types of communication networks or combinations of communication networks. The communication paths may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

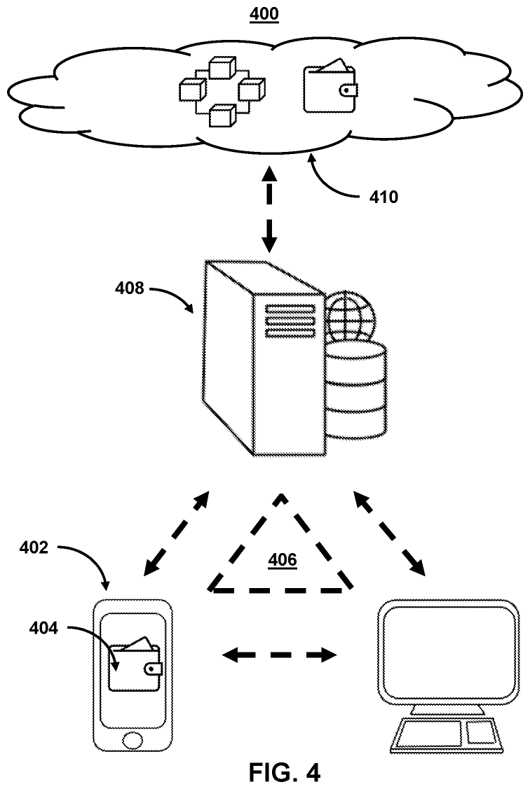

FIG. 4 shows an illustrative diagram for conducting operations in a decentralized application using blockchain operations, in accordance with one or more embodiments. For example, system 400 may include user device 402. Furthermore, user device 402 may comprise an application (e.g., application 404) that is implemented on, and/or accessible by, user device 402. For example, application 404 may interact with one or more other applications and/or application programming interfaces (APIs) in order to display a recommendation to secure a blockchain using a cryptographic asset or to cease securing the blockchain, determine one or more user characteristic (e.g., based on a user's selection of preferences), and/or the like. For example, application 404 may comprise a decentralized application digital wallet and/or wallet service that is able to sign and send transactions to transfer tokens and/or perform other blockchain operations as well as interact with one or more decentralized applications.

System 400 also includes API layer 406. In some embodiments, API layer 406 may be implemented on user device 402. Alternatively or additionally, API layer 406 may reside on one or more cloud components (e.g., server 408). For example, API layer 406 may reside on a server 408 and comprise a platform service for a custodial wallet service, decentralized application, etc. API layer 406 (which may be a representational state transfer (REST) or web services API layer) may provide a decoupled interface to data and/or functionality of one or more applications.

API layer 406 may provide various low-level and/or blockchain-specific operations in order to facilitate securing the blockchain or ceasing securing the blockchain (e.g., staking/unstaking cryptographic assets). For example, API layer 406 may provide blockchain operations such as blockchain writes. Furthermore, API layer 406 may perform a transfer validation ahead of forwarding the blockchain operation (e.g., a transaction) to another service (e.g., a crypto service). API layer 406 may then log the outcome. For example, by logging to the blockchain prior to forwarding, the API layer 406 may maintain internal records and balances without relying on external verification (e.g., which may take up to ten minutes based on blockchain updating activity).

API layer 406 may also provide informational reads. For example, API layer 406 (or a platform service powered by API layer 406) may generate blockchain operation logs and write to an additional ledger (e.g., an internal record and/or indexer service) the outcome of the reads. If this is done, a user accessing the information through other means may see consistent information such that downstream users ingest the same data point as the user.

API layer 406 may also provide a unified API to access balances, transaction histories, and/or other blockchain operations activity records between one or more decentralized applications and custodial user accounts. By doing so, the system maintains the security of sensitive information such as the balances and transaction history. Alternatively, a mechanism for maintaining such security would separate the API access between the decentralized applications and custodial user accounts through the use of special logic. The introduction of the special logic decreases the streamlining of the system, which may result in system errors based on divergence and reconciliation.

API layer 406 may provide a common, language-agnostic way of interacting with an application. In some embodiments, API layer 406 may comprise a web services API that offers a well-defined contract that describes the services in terms of their operations and the data types used to exchange information. REST APIs do not typically have this contract; instead, they are documented with client libraries for most common languages including Ruby, Java, PHP, and JavaScript. Simple Object Access Protocol (“SOAP”) web services have traditionally been adopted in the enterprise for publishing internal services as well as for exchanging information with partners in business-to-business (“B2B”) transactions.

API layer 406 may use various architectural arrangements. For example, system 400 may be partially based on API layer 406, such that there is strong adoption of SOAP and RESTful web services, using resources such as Service Repository and Developer Portal, but with low governance, standardization, and separation of concerns. Alternatively, system 400 may be fully based on API layer 406, such that separation of concerns between layers such as API layer 406, services, and applications are in place.

In some embodiments, the system architecture may use a microservice approach. Such systems may use two types of layers: front-end layers and back-end layers, where microservices reside. In this kind of architecture, the role of the API layer 406 may be to provide integration between front-end and back-end layers. In such cases, API layer 406 may use RESTful APIs (exposition to front-end or even communication between microservices). API layer 406 may use the Advanced Message Queuing Protocol (AMQP), which is an open standard for passing business messages between applications or organizations. API layer 406 may use an open-source, high-performance remote procedure call (RPC) framework that may run in a decentralized application environment. In some embodiments, the system architecture may use an open API approach. In such cases, API layer 406 may use commercial or open-source API platforms and their modules. API layer 406 may use a developer portal. API layer 406 may use strong security constraints applying a web application firewall that protects the decentralized applications and/or API layer 406 against common web exploits, bots, and denial-of-service (DDoS) attacks. API layer 406 may use RESTful APIs as standard for external integration.

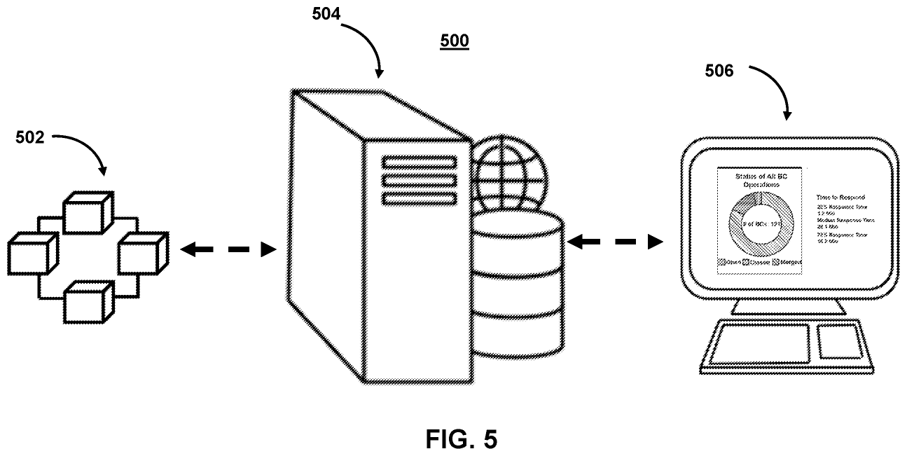

As shown in FIG. 4, system 400 may use API layer 406 to communicate with and/or facilitate blockchain operations with server 408. For example, server 408 may represent a custodial platform for blockchain operations. A custodial platform may manage private keys stored by a centralized service provider (e.g., server 408). In such cases, server 408 may interact with blockchain 410, a wallet service for blockchain 410, an indexer service for blockchain 410 (e.g., as described in FIG. 5), and/or other platform services.

For example, a wallet service may comprise an application and/or a software-based system that securely stores users' payment information, private keys, and/or passwords facilitating blockchain operations with websites, nodes, and/or other devices. In some embodiments, a wallet service may also provide additional ledger access (e.g., a second ledger). Furthermore, as discussed above, this second ledger may receive updates directly from API layer 406, as opposed to relying on data pulled directly from blockchain 410.

For example, system 400 may maintain its records (e.g., both live and for accounting) in good order separate from balances on blockchain 410. That is, system 400 may maintain an architecture featuring the second ledger, where balances are stored and updated, and the logs of blockchain operations. While conventional systems may rely on directly referencing the blockchain 410, since the blockchain is the source of truth for the system, however, such reliance leads to additional technical problems.

First, there is a strong likelihood of impedance mismatch between a format for a platform service and the APIs used to retrieve data from the blockchain (e.g., which may lead to accounting imbalances). For example, system 400 may need to be able to generate accounting entries reflecting changes of balances. However, while changes of balances can be tracked by examining blockchain 410, this requires additional processing and computational power.

Second, accounting changes in a blockchain architecture should be irreversible. This is achieved in practice for current blockchain operations by waiting for a variable number of confirmations from the blockchain (e.g., blockchain 410). By waiting for the variable number of confirmations, the likelihood of an error in the blockchain becomes infinitesimally small. However, while blockchain services rely on this methodology, this is not a rule inherent to the blockchain itself. That is, the blockchain does not have an inherent authentication mechanism that is dependent on a number of confirmations. Instead, the blockchain relies on an absolute system-blockchain operations are either recorded on a particular node or they are not.

As such, forks in the blockchain are always possible. In the case of a fork, system 400 may not follow the “right” fork for an undetermined amount of time. If that happens, and if, for the purpose of a custodial digital wallet, system 400 decides to move from one fork to another, system 400 may have a more straightforward mechanism to maintain an accurate history of a user account's positions if system 400 stores them independently from a given blockchain.

Furthermore, in case of forks, system 400 performs some internal remediation on user accounts, which is enabled by system 400 maintaining a layer of insulation, from the blockchain, for remedial blockchain operations. For example, system 400 may have a separate storage, protected by the second ledger (e.g., a ledger service), for reads, and by a transfer service, for writes, that reflect the state of the blockchain that is relevant for system 400 purposes.

In some embodiments, the system may also use one or more Application Binary Interfaces (ABIs). An ABI is an interface between two program modules, often between operating systems and user programs. ABIs may be specific to a blockchain protocol. For example, an Ethereum Virtual Machine (EVM) is a core component of the Ethereum network, and a smart contract may be a piece of code stored on the Ethereum blockchain, which are executed on EVM. Smart contracts written in high-level languages like Solidity or Vyper may be compiled in EVM executable bytecode by the system. Upon deployment of the smart contract, the bytecode is stored on the blockchain and is associated with an address. To access functions defined in high-level languages, the system translates names and arguments into byte representations for byte code to work with it. To interpret the bytes sent in response, the system converts back to the tuple (e.g., a finite ordered list of elements) of return values defined in higher-level languages. Languages that compile for the EVM maintain strict conventions about these conversions, but in order to perform them, the system must maintain the precise names and types associated with the operations. The ABI documents these names and types precisely, and in a easily parseable format, doing translations between human-intended method calls and smart-contract operations discoverable and reliable.

For example, ABI defines the methods and structures used to interact with the binary contract similar to an API, but on a lower-level. The ABI indicates the caller of the function to encode (e.g., ABI encoding) the needed information like function signatures and variable declarations in a format that the EVM can understand to call that function in bytecode. ABI encoding may be automated by the system using compilers or wallets interacting with the blockchain.

FIG. 5 shows an illustrative diagram for a blockchain indexer, in accordance with one or more embodiments. Indexer service 500 may fetch raw data (e.g., data related to a current state and/or instance of blockchain 502) from a node of a blockchain network (e.g., as described above). Indexer service 500 may then process the data and store it in a database and/or data structure in an efficient way to provide quick access to the data. For example, indexer 504 may publish and/or record a subset of blockchain operations that occur for blockchain 502. Accordingly, for subsequent blockchain operations, indexer service 500 may reference the index at indexer 504 as opposed to a node of blockchain 502 to provide various services at user device 506.

For example, indexer 504 may store a predetermined list of blockchain operations to monitor for and/or record in an index. These may include blockchain operations (e.g., “operation included,” “operation removed,” “operation finalized”) related to a given type of blockchain operation (e.g., “transaction,” “external transfer,” internal transfer,” “new contract metadata,” “ownership change,” etc.) as well as blockchain operations related to a given protocol, protocol subgroup, and/or other characteristic (e.g., “ETH,” “ERC20,” and/or “ERC721”). Additionally, and/or alternatively, the various blockchain operations and metadata related to those blockchain operations (e.g., block designations, user accounts, time stamps, etc.) as well as an aggregate of multiple blockchain operations (e.g., total blockchain operations amounts, rates of blockchain operations, rate of blockchain updates, etc.) may be monitored and/or recorded.

Indexer 504 may likewise provide navigation and search features (e.g., support Boolean operations) for the indexed blockchain operations. In some embodiments, indexer 504 may apply one or more formatting protocols to generate representations of indexed blockchain operations in a human-readable format. In some embodiments, indexer 504 may also tag blockchain operations based on whether or not the blockchain operation originated for a local user account (e.g., a user account corresponding to a custodial account) and/or a locally hosted digital wallet. Indexer service 500 may determine whether a blockchain operation contains relevant information for users of indexer service 500 by storing information about whether an address is an internal address of indexer service 500 or one used in a digital wallet hosted by a predetermined wallet service.

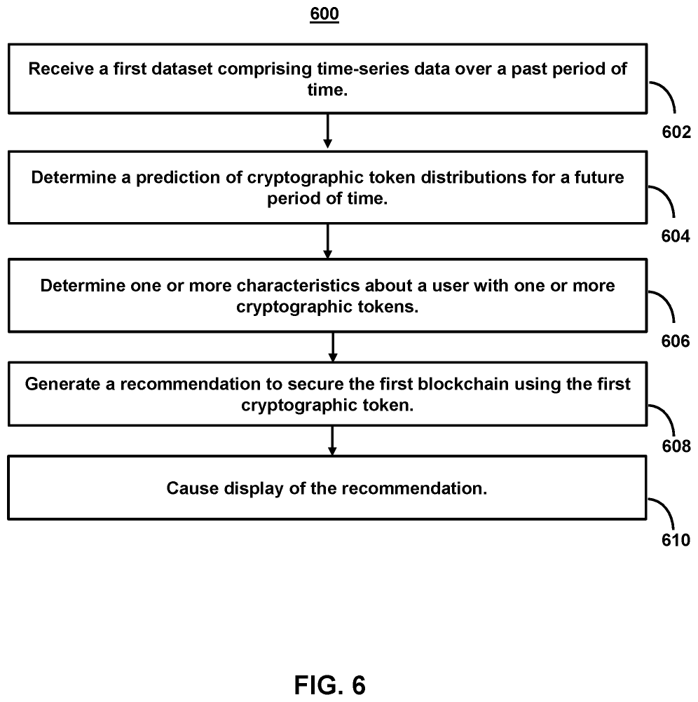

FIG. 6 shows a flowchart of the steps involved determining a prediction using one or more artificial intelligence and/or machine learning models, in accordance with one or more embodiments. For example, the system may use process 600 (e.g., as implemented on one or more system components described above) in order to predict cryptographic asset distributions for a future period of time using one or more artificial intelligence and/or machine learning models and give users the ability to make informed decisions and/or actions regarding securing a blockchain (e.g., staking) with respect to the cryptographic asset, e.g., so that they may optimize cryptographic asset distributions (e.g., staking rewards).

At step 602, process 600 (e.g., using one or more components described above) includes receiving a first dataset comprising time-series data over a past period of time. For example, the system may receive a first dataset comprising time-series data over a past period of time corresponding to a first cryptographic asset, wherein the first cryptographic asset is used to secure a first blockchain.

In some embodiments, the process 600 may include receiving (e.g., using one or more components described above) a second dataset comprising time-series data over a past period of time. For example, the system may receive a second dataset comprising time-series data over a past period of time corresponding to a first cryptographic asset. The datasets may be any suitable datasets, including ones described herein. In some embodiments, the datasets may include volume data, cryptographic asset value creation data, transaction data, and/or value data. As described herein, the datasets may be generated by the prediction system as a result of normalizing and/or preprocessing data inputs, for example, to obtain time-series data for the first dataset and/or the second dataset. In some examples, the first dataset and the second dataset further comprise time-series data over the past period of time corresponding to a second cryptographic asset for securing a second blockchain and the recommendation may be to secure the first blockchain, as compared to the second blockchain (e.g., based on which cryptographic asset would yield a higher cryptographic asset distribution in the future if a user were to stake the asset currently).

At step 604, process 600 (e.g., using one or more components described above) includes determining a prediction of cryptographic token distributions for a future period of time. For example, the system may determine, using the one or more artificial intelligence and/or machine learning models with the first dataset, a prediction of the cryptographic token distributions for the future period of time, wherein a cryptographic token distribution occurs in response to a respective cryptographic token being used to secure a respective blockchain. In one example, the system may determine a prediction of staking rewards a user may expect by staking one or more cryptographic assets. By doing so, the system may consider different options for cryptographic assets to stake, and help individuals plan for the future by giving users a sense of what to expect as well as a measure of uncertainty of the prediction (e.g., standard deviation, or a histogram showing probabilities associated with different possible predicted values). For larger entities, this can help cut down on costs of manual research, increasing accuracy and reducing costs. For example, such a system could free computational resources traditionally occupied by performing tasks such as market research, news analysis, and/or the like.

In some embodiments, process 600 may further include receiving a second dataset comprising time-series data over the past period of time corresponding to the first cryptographic asset.

In some embodiments, determining the prediction using the one or more artificial intelligence and/or machine learning models with the first dataset and the second dataset includes inputting the first dataset into a first artificial intelligence and/or machine learning model of the one or more artificial intelligence and/or machine learning models, receiving a first model output from the first artificial intelligence and/or machine learning model, inputting the first model output and the second dataset into a second artificial intelligence and/or machine learning model of the one or more artificial intelligence and/or machine learning models, wherein the second artificial intelligence and/or machine learning model is trained to determine a prediction of a value associated with respective cryptographic assets being used to secure respective blockchain, and receiving a second model output from the second artificial intelligence and/or machine learning model, wherein the second model output indicates the prediction of the value associated with respective cryptographic assets being used to secure respective blockchains. For example, the prediction of the value may include a prediction for cryptographic asset value creation rate and the prediction of the cryptographic asset distributions for the future period of time may include a prediction for an encrypted communication load.

In some embodiments, determining the prediction using the one or more artificial intelligence and/or machine learning models with the first dataset and the second dataset includes inputting dataset into an artificial intelligence and/or machine learning model trained to determine a prediction of a cryptographic asset value creation rate associated with respective cryptographic assets being used to secure respective blockchains. Determining the prediction may also include receiving a model output from the first artificial intelligence and/or machine learning model, wherein the model output indicates the prediction of the cryptographic asset value creation rate associated with respective cryptographic assets being used to secure respective blockchains.

In some embodiments, determining the prediction using the one or more artificial intelligence and/or machine learning models with the first dataset and the second dataset includes inputting the first dataset and/or the second dataset into an artificial intelligence and/or machine learning model trained to determine predictions of the cryptographic asset distributions.

Determining the prediction may also include receiving a model output from the artificial intelligence and/or machine learning model indicating the prediction of the cryptographic asset distributions for the future period of time.

At step 606, process 600 (e.g., using one or more components described above) includes determining one or more characteristics about a user with one or more cryptographic tokens. By doing so, the system may take into consideration the user's preferences and needs before providing recommendations. By considering a user's preferences, the system can provide personalized recommendations that are tailored to their specific needs and preferences, and provide recommendations that are more effective and valuable to them.

In some embodiments, determining the one or more characteristics about the user with the one or more cryptographic assets further includes obtaining user data associated with preferences of the user, and determining, based on the user data, an individual risk tolerance. In some embodiments, determining the one or more characteristics about the user with the one or more cryptographic assets further including obtaining user data regarding one or more previous blockchains secured using the one or more cryptographic assets by the user, and determining, based on the user data, historical behavior of the user.

At step 608, process 600 (e.g., using one or more components described above) includes generating a recommendation to secure the first blockchain using the first cryptographic token. For example, the system may generate a recommendation to secure the first blockchain using the first cryptographic token, wherein the first recommendation is based on the prediction of the cryptographic token distributions for the future period of time and the one or more characteristics about the user.

At step 610, process 600 (e.g., using one or more components described above) includes causing display of the recommendation, e.g., to secure the first blockchain using the first cryptographic token. For example, the system may show the recommendation on a display connected to the system, or on a display of a remote device, such as an end user's phone or computer monitor.

In some embodiments, the system may also generate a second recommendation to cease securing the first blockchain using the first cryptographic asset, e.g., based on the prediction of the cryptographic asset distributions for the future period of time and the one or more characteristics about the user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for predicting cryptographic asset distributions for a future period of time using one or more artificial intelligence and/or machine learning models, the method comprising: receiving a first dataset comprising time-series data over a past period of time corresponding to a first cryptographic asset, wherein the first cryptographic asset is used to secure a first blockchain; determining, using the one or more artificial intelligence and/or machine learning models with the first dataset, a prediction of the cryptographic asset distributions for the future period of time, wherein a cryptographic asset distribution occurs in response to a respective cryptographic asset being used to secure a respective blockchain; determining one or more characteristics about a user with one or more cryptographic assets; generating a first recommendation to secure the first blockchain using the first cryptographic asset, wherein the first recommendation is based on the prediction of the cryptographic asset distributions for the future period of time and the one or more characteristics about the user; and causing display of the first recommendation to secure the first blockchain using the first cryptographic asset.
2. The method of any one of the preceding embodiments, further comprising: receiving a second dataset comprising time-series data over the past period of time corresponding to the first cryptographic asset, and wherein determining the prediction using the one or more artificial intelligence and/or machine learning models with the first dataset and the second dataset comprises: inputting the first dataset into a first artificial intelligence and/or machine learning model of the one or more artificial intelligence and/or machine learning models; receiving a first model output from the first artificial intelligence and/or machine learning model; inputting the first model output and the second dataset into a second artificial intelligence and/or machine learning model of the one or more artificial intelligence and/or machine learning models, wherein the second artificial intelligence and/or machine learning model is trained to determine a prediction of a value associated with respective cryptographic assets being used to secure respective blockchains; and receiving a second model output from the second artificial intelligence and/or machine learning model, wherein the second model output indicates the prediction of the value associated with respective cryptographic assets being used to secure respective blockchains.
3. The method of any one of the preceding embodiments, wherein the prediction of the value comprises a prediction for cryptographic asset value creation rate and wherein the prediction of the cryptographic asset distributions for the future period of time comprises a prediction for an encrypted communication load.
4. The method of any one of the preceding embodiments, wherein determining the prediction using the one or more artificial intelligence and/or machine learning models with the first dataset and the second dataset comprises: inputting the first dataset and/or the second dataset into a first artificial intelligence and/or machine learning model of the one or more artificial intelligence and/or machine learning models, wherein the first artificial intelligence and/or machine learning model is trained to determine a prediction of a cryptographic asset value creation rate associated with respective cryptographic assets being used to secure respective blockchains; and receiving a model output from the first artificial intelligence and/or machine learning model, wherein the model output indicates the prediction of the cryptographic asset value creation rate associated with respective cryptographic assets being used to secure respective blockchains.
5. The method of any one of the preceding embodiments, wherein determining the prediction using the one or more artificial intelligence and/or machine learning models with the first dataset and the second dataset comprises: inputting the first dataset and/or the second dataset into a first artificial intelligence and/or machine learning model of the one or more artificial intelligence and/or machine learning models, wherein the first artificial intelligence and/or machine learning model is trained to determine predictions of the cryptographic asset distributions; and receiving a first model output from the first artificial intelligence and/or machine learning model, wherein the first model output indicates the prediction of the cryptographic asset distributions for the future period of time.
6. The method of any one of the preceding embodiments, further comprising: generating a second recommendation to cease securing the first blockchain using the first cryptographic asset, wherein the second recommendation to cease securing the first blockchain is based on the prediction of the cryptographic asset distributions for the future period of time and the one or more characteristics about the user.
7. The method of any one of the preceding embodiments, wherein determining the one or more characteristics about the user with the one or more cryptographic assets further comprises: obtaining user data associated with preferences of the user; and determining, based on the user data, an individual risk tolerance.
8. The method of any one of the preceding embodiments, wherein determining the one or more characteristics about the user with the one or more cryptographic assets further comprises: obtaining user data regarding one or more previous blockchains secured using the one or more cryptographic assets by the user; and determining, based on the user data, historical behavior of the user.
9. The method of any one of the preceding embodiments, wherein the first dataset and/or the second dataset comprise at least one of: volume data, cryptographic asset value creation data, transaction data, and/or value data.
10. The method of any one of the preceding embodiments, further comprising: inputting, into a preprocessor, one or more data inputs, wherein the preprocessor is configured to normalize the one or more data inputs to obtain time-series data for the first dataset and/or the second dataset.
11. A tangible, non-transitory, machine-readable medium storing instructions that, when executed by a data processing apparatus, cause the data processing apparatus to perform operations comprising those of any of embodiments 1-10.
12. A system comprising one or more processors; and memory storing instructions that, when executed by the processors, cause the processors to effectuate operations comprising those of any of embodiments 1-10.
13. A system comprising means for performing any of embodiments 1-10.

What is claimed is:

1. A system for predicting cryptographic asset distributions for a future period of time using one or more artificial intelligence models, the system comprising:
one or more processors; and
a non-transitory, computer-readable storage medium storing instructions that when executed by the one or more processors cause the one or more processors to perform operations comprising:
receiving a first dataset comprising time-series data over a past period of time corresponding to a first cryptographic asset, wherein the first cryptographic asset is used to secure a first blockchain;
determining, using the one or more artificial intelligence models with the first dataset, a prediction of the cryptographic asset distributions for the future period of time wherein a cryptographic asset distribution occurs in response to a respective cryptographic asset being used to secure a respective blockchain;
determining one or more characteristics about a user with one or more cryptographic asset;
generating a recommendation to secure the first blockchain using the first cryptographic asset, wherein the recommendation is based on the prediction of the cryptographic asset distributions for the future period of time and the one or more characteristics about the user; and
causing display of the recommendation to secure the first blockchain using the first cryptographic asset.

2. A method for predicting cryptographic asset distributions for a future period of time using one or more artificial intelligence models, the method comprising:
receiving a first dataset comprising time-series data over a past period of time corresponding to a first cryptographic asset, wherein the first cryptographic asset is used to secure a first blockchain;
determining, using the one or more artificial intelligence models with the first dataset, a prediction of the cryptographic asset distributions for the future period of time, wherein a cryptographic asset distribution occurs in response to a respective cryptographic asset being used to secure a respective blockchain;
determining one or more characteristics about a user with one or more cryptographic assets;
generating a first recommendation to secure the first blockchain using the first cryptographic asset, wherein the first recommendation is based on the prediction of the cryptographic asset distributions for the future period of time and the one or more characteristics about the user; and
causing display of the first recommendation to secure the first blockchain using the first cryptographic asset.

3. The method of claim 2, further comprising:
receiving a second dataset comprising time-series data over the past period of time corresponding to the first cryptographic asset, and
wherein determining the prediction using the one or more artificial intelligence models with the first dataset and the second dataset comprises:
inputting the first dataset into a first artificial intelligence model of the one or more artificial intelligence models;
receiving a first model output from the first artificial intelligence model;
inputting the first model output and the second dataset into a second artificial intelligence model of the one or more artificial intelligence models, wherein the second artificial intelligence model is trained to determine a prediction of a value associated with respective cryptographic assets being used to secure respective blockchains; and
receiving a second model output from the second artificial intelligence model, wherein the second model output indicates the prediction of the value associated with respective cryptographic assets being used to secure respective blockchains.

4. The method of claim 3, wherein the prediction of the value comprises a prediction for cryptographic asset value creation rate and wherein the prediction of the cryptographic asset distributions for the future period of time comprises a prediction for an encrypted communication load.

5. The method of claim 3, wherein determining the prediction using the one or more artificial intelligence models with the first dataset and the second dataset comprises:
inputting the first dataset and/or the second dataset into a first artificial intelligence model of the one or more artificial intelligence models, wherein the first artificial intelligence model is trained to determine a prediction of a cryptographic asset value creation rate associated with respective cryptographic assets being used to secure respective blockchains; and
receiving a model output from the first artificial intelligence model, wherein the model output indicates the prediction of the cryptographic asset value creation rate associated with respective cryptographic assets being used to secure respective blockchains.

6. The method of claim 3, wherein determining the prediction using the one or more artificial intelligence models with the first dataset and the second dataset comprises:
inputting the first dataset and/or the second dataset into a first artificial intelligence model of the one or more artificial intelligence models, wherein the first artificial intelligence model is trained to determine predictions of the cryptographic asset distributions; and
receiving a first model output from the first artificial intelligence model, wherein the first model output indicates the prediction of the cryptographic asset distributions for the future period of time.

7. The method of claim 2, further comprising:
generating a second recommendation to cease securing the first blockchain using the first cryptographic asset, wherein the second recommendation to cease securing the first blockchain is based on the prediction of the cryptographic asset distributions for the future period of time and the one or more characteristics about the user.

8. The method of claim 2, wherein determining the one or more characteristics about the user with the one or more cryptographic assets further comprises:
obtaining user data associated with preferences of the user; and
determining, based on the user data, an individual risk tolerance.

9. The method of claim 2, wherein determining the one or more characteristics about the user with the one or more cryptographic assets further comprises:
obtaining user data regarding one or more previous blockchains secured using the one or more cryptographic assets by the user; and
determining, based on the user data, historical behavior of the user.

10. The method of claim 3, wherein the first dataset and/or the second dataset comprise at least one of: volume data, cryptographic asset value creation data, transaction data, and/or value data.

11. The method of claim 3, further comprising:
inputting, into a preprocessor, one or more data inputs, wherein the preprocessor is configured to normalize the one or more data inputs to obtain time-series data for the first dataset and/or the second dataset.

12. A non-transitory computer readable media, comprising instructions that, when executed by one or more processors, cause operations comprising:
receiving a first dataset comprising time-series data over a past period of time corresponding to a first cryptographic asset, wherein the first cryptographic asset is used to secure a first blockchain;
determining, using one or more artificial intelligence models with the first dataset, a prediction of cryptographic asset distributions for a future period of time, wherein a cryptographic asset distribution occurs in response to a respective cryptographic asset being used to secure a respective blockchain;
determining one or more characteristics about a user with one or more cryptographic assets;
generating a first recommendation to secure the first blockchain using the first cryptographic asset, wherein the first recommendation is based on the prediction of the cryptographic asset distributions for the future period of time and the one or more characteristics about the user; and
causing display of the first recommendation to secure the first blockchain using the first cryptographic asset.

13. The non-transitory computer readable media of claim 12, further comprising:
receiving a second dataset comprising time-series data over the past period of time corresponding to the first cryptographic asset, and
wherein the instructions for determining the prediction using the one or more artificial intelligence models with the first dataset and the second dataset further comprises:
inputting the first dataset into a first artificial intelligence model of the one or more artificial intelligence models;
receiving a first model output from the first artificial intelligence model;
inputting the first model output and the second dataset into a second artificial intelligence model of the one or more artificial intelligence models, wherein the second artificial intelligence model is trained to determine a prediction of a value associated with respective cryptographic assets being used to secure respective blockchains; and
receiving a second model output from the second artificial intelligence model, wherein the second model output indicates the prediction of the value associated with respective cryptographic assets being used to secure respective blockchains.

14. The non-transitory computer readable media of claim 13, wherein the prediction of the value comprises a prediction for cryptographic asset value creation rate and wherein the prediction of the cryptographic asset distributions for the future period of time comprises a prediction for an encrypted communication load.

15. The non-transitory computer readable media of claim 13, wherein determining the prediction using the one or more artificial intelligence models with the first dataset and the second dataset comprise:
inputting the first dataset and/or the second dataset into a first artificial intelligence model of the one or more artificial intelligence models, wherein the first artificial intelligence model is trained to determine a prediction of a cryptographic asset value creation rate associated with respective cryptographic assets being used to secure respective blockchains; and
receiving a model output from the first artificial intelligence model, wherein the model output indicates the prediction of the cryptographic asset value creation rate associated with respective cryptographic assets being used to secure respective blockchains.

16. The non-transitory computer readable media of claim 13, wherein determining the prediction using the one or more artificial intelligence models with the first dataset and the second dataset comprises:
inputting the first dataset and/or the second dataset into a first artificial intelligence model of the one or more artificial intelligence models, wherein the first artificial intelligence model is trained to determine predictions of cryptographic asset distributions; and
receiving a first model output from the first artificial intelligence model, wherein the first model output indicates a prediction of the cryptographic asset distributions for the future period of time.

17. The non-transitory computer readable media of claim 12, wherein the instructions cause the one or more processors to perform operations comprising:
generating a second recommendation to cease securing the first blockchain using the first cryptographic asset, wherein the second recommendation to cease securing the first blockchain is based on the prediction of the cryptographic asset distributions for the future period of time and the one or more characteristics about the user.

18. The non-transitory computer readable media of claim 12, wherein determining the one or more characteristics about the user with one or more cryptographic assets comprises:
obtaining user data associated with preferences of the user; and
determining, based on the user data, an individual risk tolerance.

19. The non-transitory computer readable media of claim 12, wherein determining the one or more characteristics about the user with one or more cryptographic assets further comprises:
obtaining user data regarding one or more previous blockchains secured using the one or more cryptographic assets by the user; and
determining, based on the user data, historical behavior of the user.

20. The non-transitory computer readable media of claim 13, wherein the first dataset and/or the second dataset comprise at least one of: volume data, cryptographic asset value creation data, transaction data, and/or value data.
